(19) United States
(12) Patent Application Publication
(10) Pub. No.: US 2012/0042038 A1
(43) Pub. Date: Feb. 16, 2012

(54) POINT-OF-SALE SYSTEM, WIRELESS TRANSMISSION DEVICE, AND DATA TRANSMISSION METHOD IMPLEMENTED BY THE POINT-OF-SALE SYSTEM

(76) Inventors: Tai-Seng LAM, Taipei City (TW); Chiung-Chi Lin, Taipei City (TW); Hsiu-Yi Wu, Taipei City (TW); Ching-Yi Lin, Taipei City (TW)

(21) Appl. No.: 12/950,573

(22) Filed: Nov. 19, 2010

(30) Foreign Application Priority Data
Aug. 13, 2010 (TW) 099127108

(51) Int. Cl. G06F 15/16

(52) U.S. Cl. 709/217

(57) ABSTRACT

A point-of-sale (POS) system includes a POS host, a plurality of client devices, and a wireless transmission device. The wireless transmission device includes a host-end wireless communication module coupled to the POS host, and a plurality of client-end wireless communication modules coupled respectively to the client devices. The POS host is operable to configure the host-end wireless communication module for generating a plurality of virtual COM ports. Each of the virtual COM ports is matched with a respective one of the client-end wireless communication modules, such that the POS host is able to communicate wirelessly with the client devices through the host-end wireless communication module and the client-end wireless communication modules.

### CROSS-REFERENCE TO RELATED APPLICATION

This application claims priority of Taiwanese Application No. 099127108, filed on Aug. 13, 2010.

### BACKGROUND OF THE INVENTION

1. Field of the Invention

The present invention relates to a point-of-sale system, more particularly to a point-of-sale system utilizing wireless transmission technology.

2. Description of the Related Art

Point-of-sale (POS) systems have been broadly utilized in stores such as convenient stores, malls, restaurants, etc. Generally, data transmission between a POS host and a client device is conducted through a transmission line. However, the physical transmission line imposes restrictions on the deployment distances between the POS host and the client devices, and the deployed regions or locations of the client devices are limited thereby. Moreover, the transmission lines and power lines of the POS system make the stores look messy, and have an adverse affect on the aesthetic and integrity of the store decoration.

### SUMMARY OF THE INVENTION

Therefore, an object of the present invention is to provide a point-of sale (POS) system capable of transmitting data wirelessly.

Accordingly, the POS system of this invention includes a POS host, a plurality of client devices, and a wireless transmission device. The wireless transmission device includes a host-end wireless communication module coupled to the POS host, and a plurality of client-end wireless communication modules coupled respectively to the client devices. The POS host is operable to configure the host-end wireless communication module for generating a plurality of virtual COM ports. Each of the virtual COM ports is matched with a respective one of the client-end wireless communication modules, such that the POS host is able to communicate wirelessly with the client devices through the host-end wireless communication module and the client-end wireless communication modules.

Another object of the present invention is to provide a wireless transmission device that is able to generate a plurality of virtual COM ports for wireless signal communications.

Accordingly, the wireless transmission device of this invention is adapted for establishing wireless transmission between a point-of-sale (POS) host and a plurality of client devices. The wireless transmission device includes a host-end wireless communication module adapted to be coupled to the POS host for transmitting and receiving signals wirelessly, and a plurality of client-end wireless communication modules adapted to be coupled to the client devices, respectively, for transmitting and receiving signals wirelessly. Moreover, the host-end wireless communication module is configurable via the POS host to generate a plurality of virtual COM ports. Each of the virtual COM ports is matched with a respective one of the client-end wireless communication modules, such that the POS host is able to communicate wirelessly with the client devices through the host-end wireless communication module and the client-end wireless communication modules.

Still another object of the present invention is to provide a data transmission method implemented by a point-of-sale (POS) system so that data may be transmitted without loss.

Accordingly, the data transmission method of this invention is to be implemented by a point-of-sale (POS) system that includes a POS host and a plurality of client devices. The data transmission method includes the steps of:

(A) coupling a host-end wireless communication module to the POS host, and coupling each of a plurality of client-end wireless communication modules to a respective one of the client devices;

(B) using the POS host, configuring the host-end communication module to generate a plurality of virtual COM ports, each of the virtual COM ports being matched with a respective one of the client-end wireless communication modules;

(C) upon detection by the host-end wireless communication module that one of the virtual COM ports has received data from a matching one of the client-end wireless communication modules, configuring the host-end wireless communication module to send an acknowledge signal to the matching one of the client-end wireless communication modules; and

(D) upon detection by one of the client-end wireless communication modules that data has been received from the host-end wireless communication module, configuring said one of the client-end wireless communication modules to send an acknowledge signal to the host-end wireless communication module.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram illustrating connecting relationships among software and hardware modules of a preferred embodiment of the POS system of the present invention;

FIG. 2 is a diagram similar to FIG. 1, but illustrating that a wireless transmission device may generate a plurality of virtual COM ports, each of which is matched with a respective one of the client-end wireless communication modules;

FIG. 3 is a schematic diagram of an operation interface of a matching utility program, illustrating that the matching utility program may be executed to search for surrounding client-end wireless communication modules;

FIG. 4 is a diagram similar to FIG. 3, but illustrating that the matching utility program has been executed to match each of the virtual COM ports with the respective one of the client-end wireless communication modules;

FIG. 5 is a flowchart illustrating steps involved when a host-end wireless communication module transmits data to the client-end wireless communication modules; and

FIG. 6 is a flowchart illustrating steps involved when one of the client-end wireless communication modules transmits data to the host-end wireless communication module.

### DETAILED DESCRIPTION OF THE PREFERRED EMBODIMENT

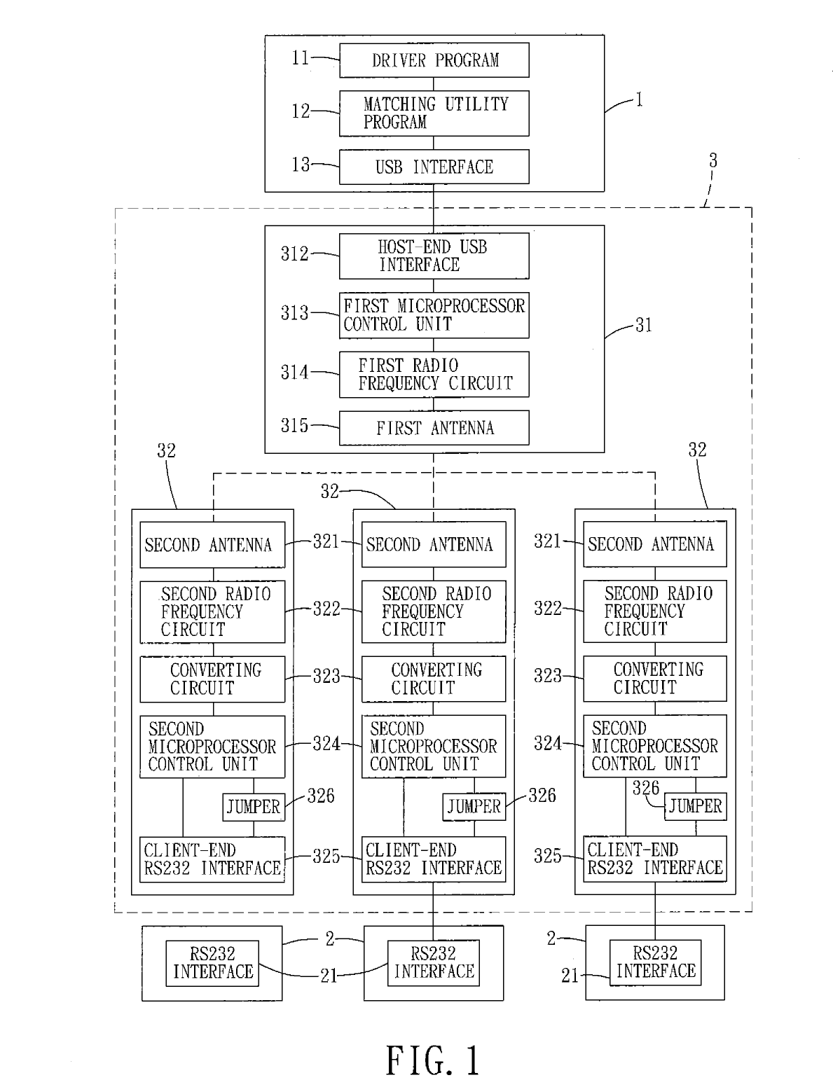

Referring to FIG. 1, a preferred embodiment of the POS system of the present invention includes a POS host 1, a plurality of client devices 2, and a wireless transmission device 3. In this embodiment, each of the client devices 2 is a respective one of a client-end display, a bar code scanner and a printer, and each of the client devices 2 includes a RS232 interface 21. The POS host 1 includes a USB interface 13. The wireless transmission device 3 is operable for wireless communication according to the IEEE 802.11 standard, and for data transmission in the 2.4 G ISM frequency band, at a bit rate of 250 kbps, at a baud rate ranging from 4800 Bd to 38400 Bd, and at a transmission distance ranging from 0 to 30 meters.

The wireless transmission device 3 includes a host-end wireless communication module 31 coupled to the POS host 1, and a plurality of client-end wireless communication modules 32 coupled respectively to the client devices 2. The host-end wireless communication module 31 includes a host-end USB interface 312 for connecting with the POS host 1, a first microprocessor control unit (MCU) 313 connected electrically to the host-end USB interface 312, a first radio frequency circuit 314 connected electrically to the first MCU 313, and a first antenna 315 connected electrically to the first radio frequency circuit 314 for transmitting and receiving signals wirelessly. The host-end wireless communication module 31 is pluggable for connecting electrically to the POS host 1 via the host-end USB interface 312, and is supplied with power from the POS host 1. In other embodiments, the host-end wireless communication module 31 may be built-in and integrated with the POS host 1.

Each of the client-end wireless communication modules 32 includes a client-end RS232 interface 325 for connecting with a respective one of the client devices 2, a second MCU 324 connected electrically to the client-end RS232 interface 325, a jumper 326 connected electrically to the second MCU 324, a converting circuit 323 connected electrically to the second MCU 324, a second radio frequency circuit 322 connected electrically to the converting circuit 323, and a second antenna 321 connected electrically to the second radio frequency circuit 322 for transmitting and receiving signals wirelessly. Each of the client-end wireless communication modules 32 is pluggable for connecting electrically to a respective one of the client devices 2 via the client-end RS232 interface 325. In other embodiments, each of the client-end wireless communication modules 32 maybe built-in and integrated with a respective one of the client devices 2.

Each of the jumpers 326 is operable to set a device type of the respective one of the client devices 2 to which the respective one of client-end wireless communication module 32 is coupled, for example inserting the jumper 326 into one of a set of terminals (not shown) of the client-end wireless communication module 32 so as to set that the client-end wireless communication module 32 is connected electrically to a corresponding one of the client-end display, the bar code scanner, or the printer. Each of the jumpers 326 maybe replaced by a dual in-line package switch in other embodiments of this invention. The converting circuits 323 is for converting format of transmitted data between a USB data format and a RS232 data format. In this embodiment, each of the client-end wireless communication modules 32 is supplied with a direct current as input power, and the input power ranges from 5V to 12V.

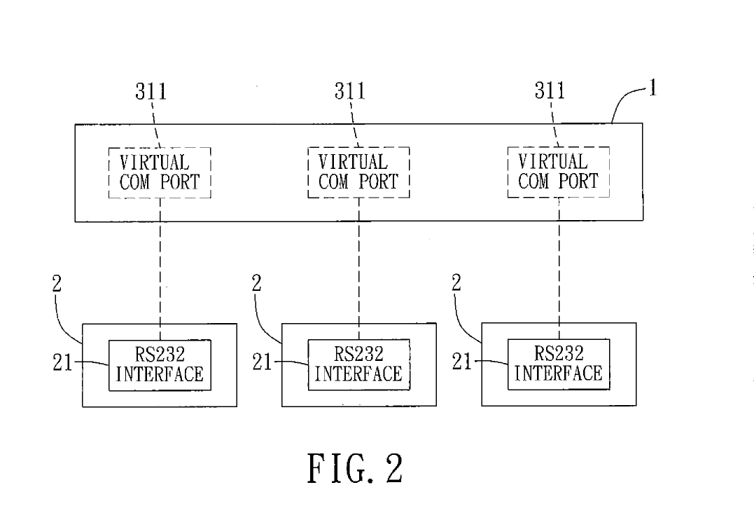

The POS host 1 is installed with a driver program 11 and a matching utility program 12. In this embodiment, the driver program 11 and the matching utility program support conventional operating systems, such as Windows 2000, Windows XP, Windows Vista, Windows 7, Windows CE, etc. The POS host 1 drives and configures the host-end wireless communication module 31 when the driver program 11 is executed thereby, such that the host-end wireless communication module 31 is configured to generate a plurality of virtual COM ports 311, each of which is to be matched with a respective one of the client-end wireless communication modules 32 as shown in FIG. 2. Subsequently, the POS host 1 matches each of the virtual COM ports 311 generated by the host-end wireless communication module 31 with the respective one of the client-end wireless communication modules 32 when the matching utility program 12 is executed thereby.

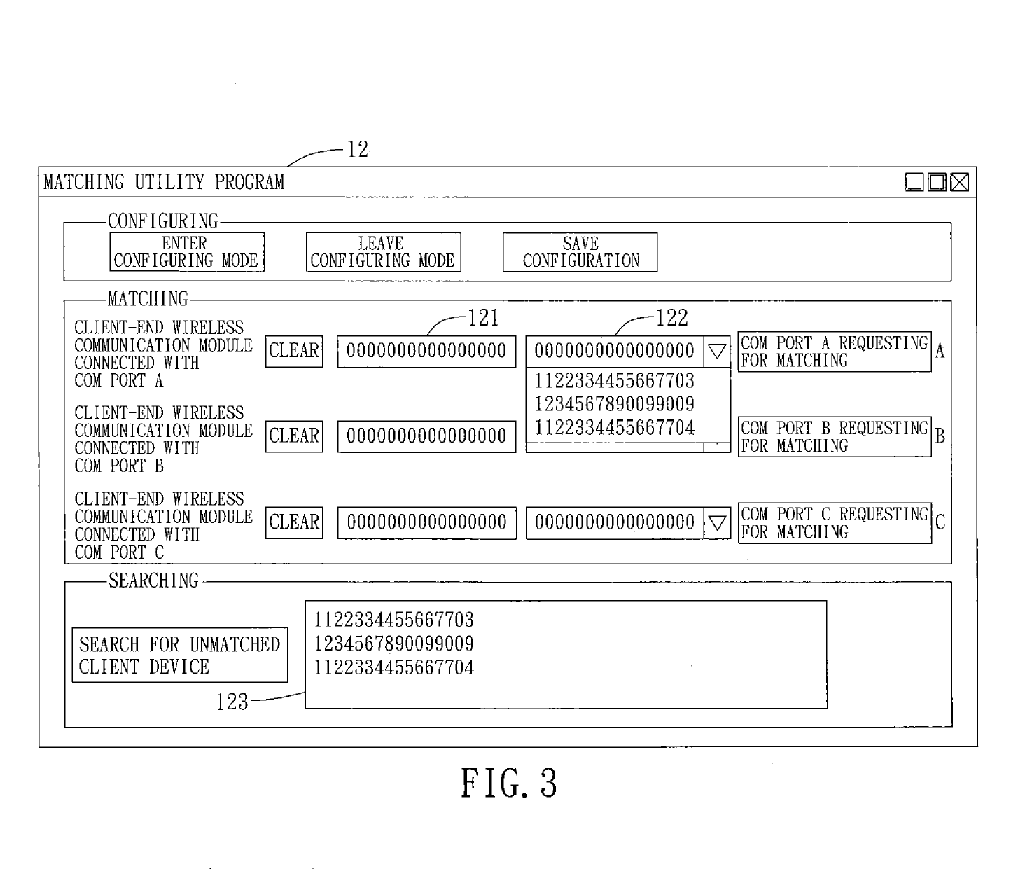

Referring to FIG. 1 and FIG. 3, when the matching utility program 12 is executed, users are able to select an “Enter Configuring Mode” option in a first page, which is generated by the matching utility program 12, displayed on a display screen of the POS host 1. Users subsequently select a “Search For Unmatched Client Device” option so that the host-end wireless communication module 31 is enabled to search for any unmatched client-end wireless communication module 32, and address of the unmatched client-end wireless communication module 32 thus found is shown in an unmatched address block 123. Next, users may select a pull down menu 122 and choose the address of the to-be-matched client-end wireless communication module 32.

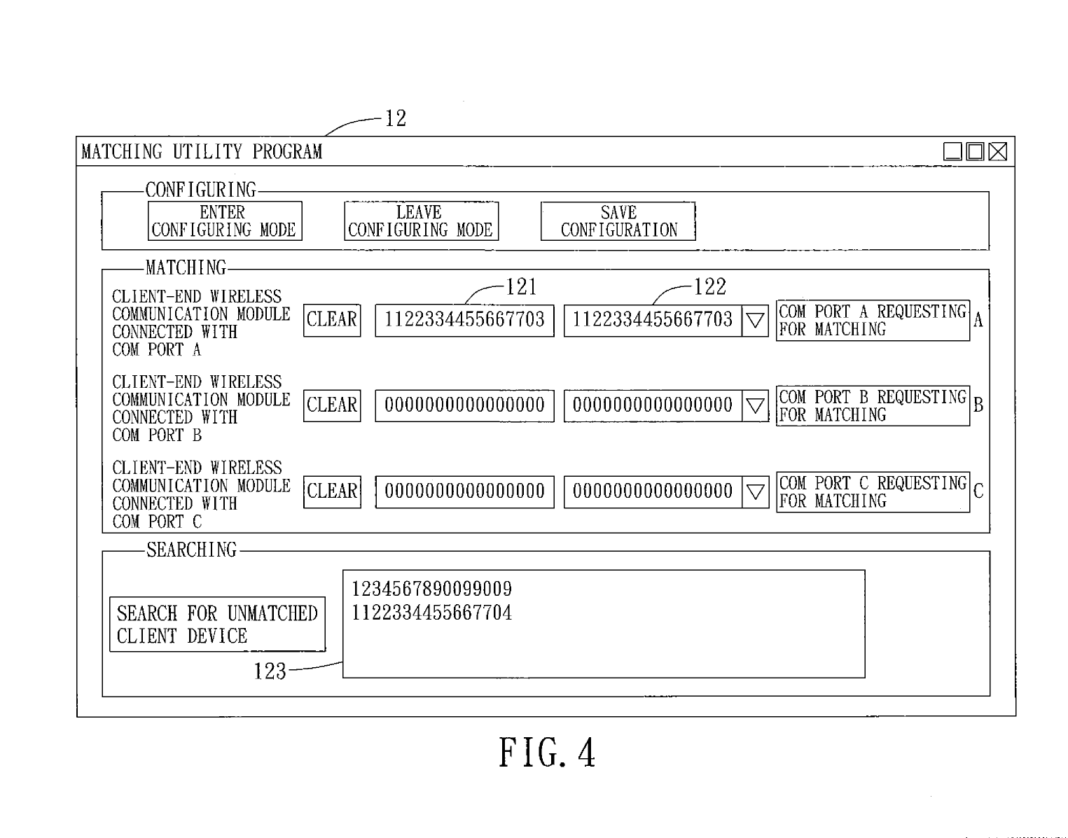

Referring to FIG. 1 and FIG. 4, users may subsequently select a “COM Port A Requesting For Matching” option to establish a match between one of the virtual COM ports 311 and a respective one of the client-end wireless communication modules 32. The address of the matched client-end wireless communication module 32 will be displayed in a matched address block 121 after matching is established. Users may establish matching between the other two virtual COM ports 311 and the other client-end wireless communication modules 32 by following the steps described above. Users may change a target to be matched via selecting a “Clear” option to disable the previous match followed by establishing a new match with another one of the client-end wireless communication modules 32 by the steps described above. After finishing the configuration operation, users may select a “Save Configurations” option followed by selecting a “Leave Configuring Mode” option to exit the configuring mode. It is worth mentioning that the host-end wireless communication module 31 and the client-end wireless communication modules 32 are configured to store erasable matching information associated with the virtual COM ports 311.

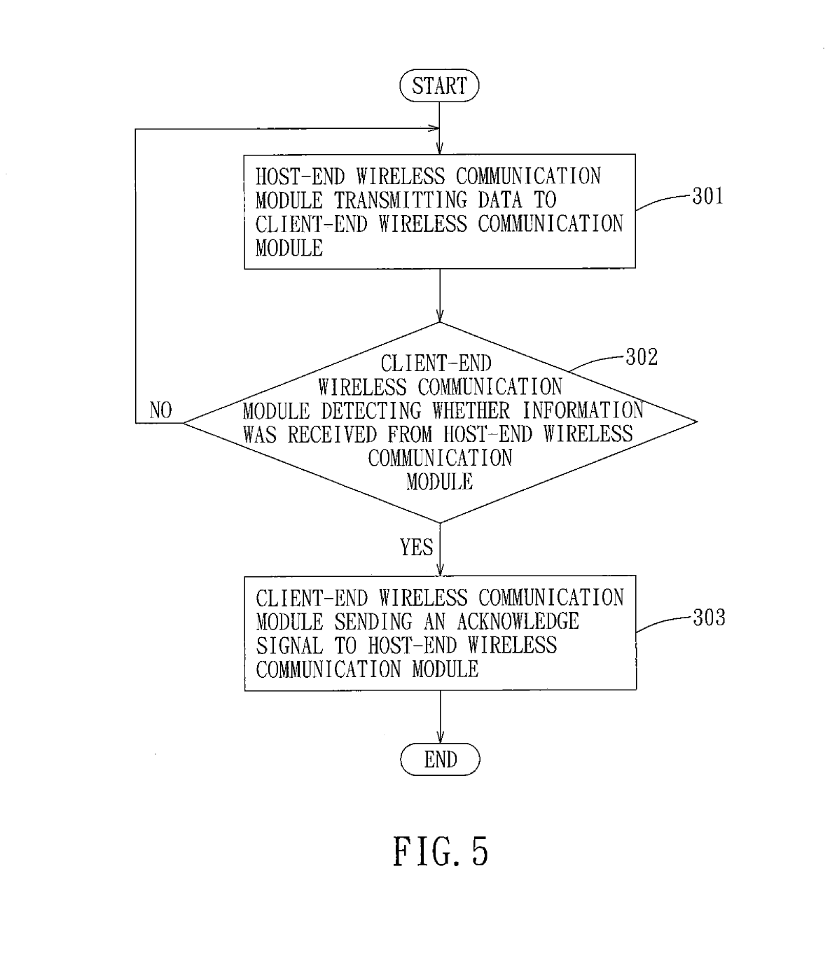

Referring to FIG. 1 and FIG. 5, after matching, when the POS host 1 intends to send information to the client-end wireless communication modules 2 (for example, the POS host 1 sending information to the printer for printing receipts or sending information to the client-end display for showing customers' transaction amount), as depicted in step 301, the information that is to be transmitted by the POS host 1 is transmitted via the host-end wireless communication module 31 to the intended client-end wireless communication module 32. Referring to step 302, each of the client-end wireless communication modules 32 detects whether information was received from the POS host 1. If affirmative, referring to step 303, the client-end wireless communication module 32 sends an acknowledge signal to the host-end wireless communication module 31. Otherwise, the host-end wireless communication module 31 continues sending the information until the acknowledge signal is received from the client-end wireless communication module 32.

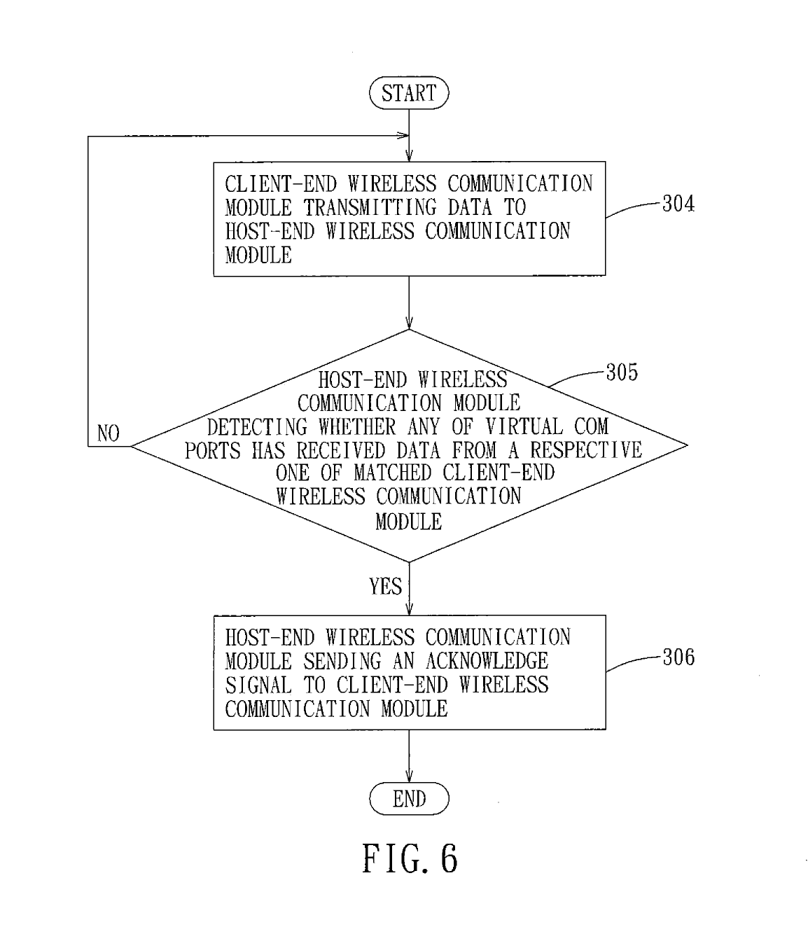

Referring to FIG. 1 and FIG. 6, when one of the client-end wireless communication modules 32 intends to send information to the POS host 1 (for example, the bar code scanner sending information of commodity purchased by customers to the POS host 1), as depicted in step 304, the information that is to be transmitted by one of the client devices 2 is transmitted via the respective one of the client-end wireless communication modules 32 to the host-end wireless communication module 31. Referring to step 305, the host-end wireless communication module 31 detects whether any of the virtual COM ports 311 has received data from the respective one of the matched client-end wireless communication modules 32. If affirmative, referring to step 306, the host-end wireless communication module 31 sends an acknowledge signal to the respective one of the client-end wireless communication modules 32. Otherwise, the client-end wireless communication modules 32 continues sending the information until the acknowledge signal is received from the host-end wireless communication module 31.

In summary, the POS system of the present invention enables the POS host 1 to communicate wirelessly with the client devices 2 via the host-end wireless communication module 31 and the client-end wireless communication modules 32 of the wireless transmission device 3. The host-end wireless communication module 31 is able to be matched and to communicate with a plurality of the client devices 2 by means of the virtual COM ports 311 generated by the host-end wireless communication module 31, and the POS host 1 may regard the virtual COM ports 311 as physical COM ports to communicate in a conventional way. Furthermore, users need not worry about loss of data attributed to going beyond an area of coverage during operation due to the data transmission method implemented by the POS system. Thus, the POS system of the present invention enables the deployment locations and distances between the POS host 1 and the client devices 2 to be not limited by physical transmission lines, and reduces affect on aesthetic and integrity of the store decoration by virtue of substituting wireless communication for wired communication.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A point-of-sale (POS) system comprising:
a POS host;
a plurality of client devices; and
a wireless transmission device including a host-end wireless communication module coupled to said POS host, and a plurality of client-end wireless communication modules coupled respectively to said client devices;
said POS host being operable to configure said host-end wireless communication module for generating a plurality of virtual COM ports, each of which is matched with a respective one of said client-end wireless communication modules, such that said POS host is able to communicate wirelessly with said client devices through said host-end wireless communication module and said client-end wireless communication modules.

2. The POS system as claimed in claim 1, wherein said POS host is installed with a driver program, said POS host driving and configuring said host-end wireless communication module when said driver program is executed thereby.

3. The POS system as claimed in claim 1, wherein said POS host is installed with a matching utility program, said POS host matching each of said virtual COM ports generated by said host-end wireless communication module with the respective one of said client-end wireless communication modules when said matching utility program is executed thereby.

4. The POS system as claimed in claim 1, wherein each of said client-end wireless communication modules includes one of a dual in-line package switch and a jumper for setting a device type of said client device to which said client-end wireless communication module is coupled.

5. The POS system as claimed in claim 1, wherein said host-end wireless communication module is pluggable for connecting electrically to said POS host, each of said client-end wireless communication modules being pluggable for connecting electrically to the respective one of said client devices.

6. The POS system as claimed in claim 1, wherein said host-end wireless communication module includes a host-end USB interface for connecting to said POS host, each of said client-end wireless communication modules including a client-end RS232 interface for connecting to the respective one of said client devices.

7. The POS system as claimed in claim 1, wherein said wireless transmission device is operable for wireless communication according to the IEEE 802.11 standard and for data transmission in the 2.4 G ISM frequency band.

8. The POS system as claimed in claim 1, wherein said host-end wireless communication module and said client-end wireless communication modules are configured to store erasable matching information associated with said virtual COM ports.

9. A wireless transmission device adapted for establishing wireless transmission between a point-of-sale (POS) host and a plurality of client devices, said wireless transmission device comprising:
a host-end wireless communication module adapted to be coupled to the POS host for transmitting and receiving signals wirelessly; and
a plurality of client-end wireless communication modules adapted to be coupled to the client devices, respectively, for transmitting and receiving signals wirelessly;
wherein said host-end wireless communication module is configurable via the POS host to generate a plurality of virtual COM ports, each of which is matched with a respective one of said client-end wireless communication modules, such that the POS host is able to communicate wirelessly with the client devices through said host-end wireless communication module and said client-end wireless communication modules.

10. The wireless transmission device as claimed in claim 9, further comprising a driver program to be installed in and executed by the POS host such that the POS host is able to drive and configure said host-end wireless communication module.

11. The wireless transmission device as claimed in claim 9, further comprising a matching utility program to be installed in and executed by the POS host such that the POS host is able to match each of said virtual COM ports generated by said host-end wireless communication module with the respective one of said client-end wireless communication modules.

12. The wireless transmission device as claimed in claim 9, wherein each of said client-end wireless communication modules includes one of a dual in-line package switch and a jumper for setting a device type of the client device to which said client-end wireless communication module is coupled.

13. The wireless transmission device as claimed in claim 9, wherein said host-end wireless communication module is pluggable for connecting electrically to the POS host, and each of said client-end wireless communication modules is pluggable for connecting electrically to the respective one of the client devices.

14. The wireless transmission device as claimed in claim 9, wherein said host-end wireless communication module includes a host-end USB interface for connecting to the POS host, and each of said client-end wireless communication modules includes a client-end RS232 interface for connecting to the respective one of the client devices.

15. The wireless transmission device as claimed in claim 9, wherein said wireless transmission device is operable for wireless communication according to the IEEE 802.11 standard and for data transmission in the 2.4 G ISM frequency band.

16. The wireless transmission device as claimed in claim 9, wherein said host-end wireless communication module and said client-end wireless communication modules are configured to store erasable matching information associated with said virtual COM ports.

17. A data transmission method to be implemented by a point-of-sale (POS) system including a POS host and a plurality of client devices, the data transmission method comprising the steps of:
(A) coupling a host-end wireless communication module to the POS host, and coupling each of a plurality of client-end wireless communication modules to a respective one of the client devices;
(B) using the POS host, configuring the host-end communication module to generate a plurality of virtual COM ports, each of which is matched with a respective one of the client-end wireless communication modules;
(C) upon detection by the host-end wireless communication module that one of the virtual COM ports has received data from a matching one of the client-end wireless communication modules, configuring the host-end wireless communication module to send an acknowledge signal to the matching one of the client-end wireless communication modules; and
(D) upon detection by one of the client-end wireless communication modules that data has been received from the host-end wireless communication module, configuring said one of the client-end wireless communication modules to send an acknowledge signal to the host-end wireless communication module.

18. The data transmission method as claimed in claim 17, wherein, in step (B), the POS host is installed with a driver program, and the POS host drives and configures the host-end wireless communication module when the driver program is executed thereby.

19. The data transmission method as claimed in claim 17, wherein, in step (B), the POS host is installed with a matching utility program, and the POS host matches each of the virtual COM ports generated by the host-end wireless communication module with the respective one of the client-end wireless communication modules when the matching utility program is executed thereby.

20. The data transmission method as claimed in claim 17, wherein the host-end wireless communication module and the client-end wireless communication modules are operable for wireless communication according to the IEEE 802.11 standard and for data transmission in the 2.4 G ISM frequency band.

21. The data transmission method as claimed in claim 17, wherein, instep (B), each of the host-end wireless communication module and the client-end wireless communication modules is configured to store erasable matching information associated with the virtual COM ports.
